(19) United States
(12) Patent Application Publication
(10) Pub. No.: US 2012/0023513 A1
(43) Pub. Date: Jan. 26, 2012

(54) Motor and optical disc drive using the same

(75) Inventors: Jin Sun Min, Suwon (KR); Sang Kyu Lee, Suwon (KR); Byung Hoon Lee, Suwon (KR)

(73) Assignee: SAMSUNG ELECTRO-MECHANICS CO., LTD., Suwon (KR)

(21) Appl. No.: 13/137,173

(22) Filed: Jul. 25, 2011

(30) Foreign Application Priority Data
Jul. 26, 2010 (KR) 10-2010-0071963

(51) Int. Cl. H02K 11/00; G11B 19/20

(52) U.S. Cl. 720/695; 310/68 R; G9B/19.027

(57) ABSTRACT

There is provided a motor having an improved coupling structure between a circuit board and a base plate, and an optical disc drive using the same. The motor includes: a base plate; and a circuit board coupled to a surface of the base plate and having insulating layers formed on both surfaces thereof, wherein the insulating layers formed on both surfaces of the circuit board have different thicknesses. In particular, an insulating layer formed on one surface of the circuit board attached to the base plate may be thicker than an insulating layer formed on the other surface thereof.

### CROSS-REFERENCE TO RELATED APPLICATIONS

This application claims the priority of Korean Patent Application No. 10-2010-0071963 filed on Jul. 26, 2010, in the Korean Intellectual Property Office, the disclosure of which is incorporated herein by reference.

### BACKGROUND OF THE INVENTION

1. Field of the Invention

The present invention relates to a motor and an optical disc drive using the same, and more particularly, to a motor having an improved coupling structure between a circuit board and a base plate, and an optical disc drive using the same.

2. Description of the Related Art

Generally, a spindle motor mounted in an optical disc drive serves to rotate a disc so that an optical pickup mechanism can read data recorded on the disc.

In a spindle motor according to the related art, a base plate has a sleeve holder fixed thereto at a center part thereof through a spinning method, a caulking method, or the like, the sleeve holder having a core coupled thereto. In addition, the base plate has a circuit board mounted thereon.

In the spindle motor according to the related art, a method in which double-sided adhesive tape is interposed between the circuit board and the base plate to thereby attach the circuit board to the base plate has been used.

The double-sided adhesive tape serves to increase a manufacturing cost of the motor. However, in the case that the circuit board is attached directly onto the base plate without the use of double-sided adhesive tape, a short circuit between the circuit board and the base plate may be generated. Therefore, a method capable of preventing a short circuit between the circuit board and the base plate without using the double-sided adhesive tape is required.

### SUMMARY OF THE INVENTION

An aspect of the present invention provides a motor in which a circuit board may be easily coupled to a base plate without using double-sided adhesive tape by improving a coupling structure between the base plate and the circuit board, and an optical disc drive using the same.

According to an aspect of the present invention, there is provided a motor including: a base plate having a stator coupled thereto; and a circuit board coupled to a surface of the base plate and having insulating layers formed on both surfaces thereof, wherein the insulating layers formed on the both surfaces of the circuit board have different thicknesses.

An insulating layer formed on one surface of the circuit board attached to the base plate may be thicker than an insulating layer formed on the other surface of the circuit board.

The insulating layer on one surface of the circuit board may include: a first insulating layer formed on the circuit board; a second insulating layer formed on the first insulating layer; and a third insulating layer partially formed on the second insulating layer.

The first and second insulating layers may be made of the same insulating material.

The insulating material may be a solder resist.

The first and second insulating layers may be made of different insulating materials.

The first insulating layer may be made of a solder resist, and the second insulating layer may be formed of a prepreg sheet.

The insulating layer on one surface of the circuit board may be formed of a prepreg sheet.

The third insulating layer may be formed through screen printing.

The third insulating layer may be formed in portions of the circuit board in which terminals are exposed to the outside.

The third insulating layer may be made of a resin material.

The motor may further include an adhesive layer interposed between the base plate and the circuit board.

The adhesive layer may be formed on an upper surface of the second insulating layer and may have the same thickness as that of the third insulating layer.

The motor may further include a fixing member fixedly coupling the circuit board and the base plate to each other.

The fixing member may be any one of a screw or a rivet.

According to another aspect of the present invention, there is provided a motor including: a base plate having a stator coupled thereto; and a circuit board coupled to a surface of the base plate and having an insulating layer formed on a surface thereof contacting the surface of the base plate, wherein the insulating layer has a thickness of 45 to 75 μm.

According to another aspect of the present invention, there is provided a motor including: a base plate having a stator coupled thereto; and a circuit board coupled to a surface of the base plate and having an insulating layer formed on a surface thereof (a contact surface) contacting the surface of the base plate, wherein the insulating layer includes: a first insulating layer formed across the contact surface of the circuit board; and a third insulating layer partially formed on the first insulating layer.

The insulating layer may further include a second insulating layer interposed between the first and third insulating layers.

The insulating layer may be formed to have an overall thickness of 45 to 75 μm.

According to another aspect of the present invention, there is provided an optical disc drive including: the motor as described above; and an optical pickup mechanism mounted to be movable in a space below a disc loaded on the motor and receiving data from the disc.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a motor according to an exemplary embodiment of the present invention;

FIG. 2 is a partially enlarged cross-sectional view of part A of FIG. 1;

FIGS. 3A through 3D are views describing a method of manufacturing a circuit board of FIG. 1;

FIG. 4 is a cross-sectional view schematically showing a portion of a motor according to another exemplary embodiment of the present invention; and

FIG. 5 is a cross-sectional view schematically showing an optical disc drive according to an exemplary embodiment of the present invention.

### DETAILED DESCRIPTION OF THE PREFERRED EMBODIMENT

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to most appropriately describe the best method he or she knows for carrying out the invention. Therefore, the configurations described in the embodiments and drawings of the present invention are merely the most preferable embodiments but do not represent all of the technical spirit of the present invention. Thus, the present invention should be construed as including all the changes, equivalents, and substitutions included in the spirit and scope of the present invention at the time of the filing of this application.

Hereinafter, exemplary embodiments of the present invention will be described in detail with reference to the accompanying drawings. At this time, it is noted that like reference numerals denote like elements in appreciating the drawings. Moreover, detailed descriptions related to well-known functions or configurations will be ruled out in order not to unnecessarily obscure the subject matter of the present invention. Based on the same reason, it is to be noted that some components shown in the drawings are exaggerated, omitted or schematically illustrated, and the size of each component does not exactly reflect its real size.

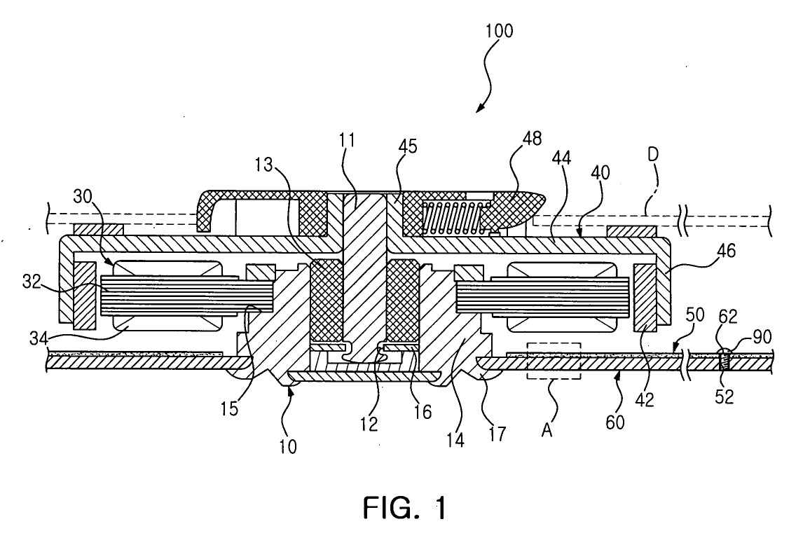

Meanwhile, terms relating to directions will be defined. As viewed in FIG. 1, an axial direction refers to a vertical direction based on a shaft 11, and an outer diameter or inner diameter direction refers to a direction towards an outer edge of a rotor 40 based on the shaft 11 or a direction towards the center of the shaft 11 based on the outer edge of the rotor 40.

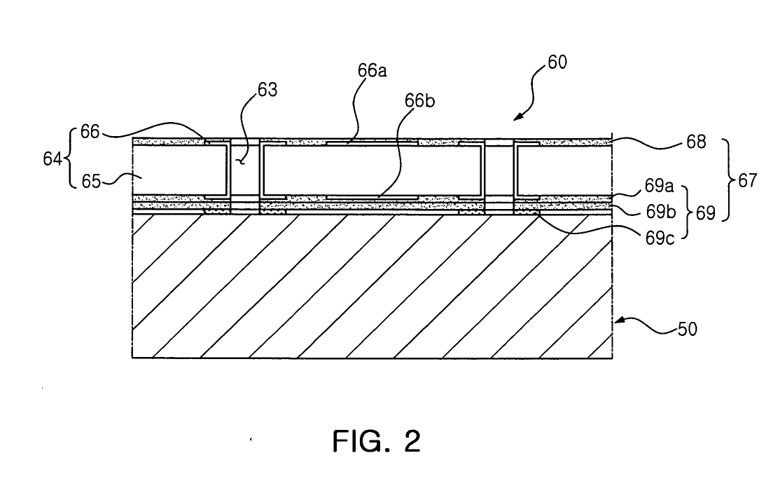

FIG. 1 is a cross-sectional view schematically showing a motor according to an exemplary embodiment of the present invention, and FIG. 2 is a partially enlarged cross-sectional view of part A of FIG. 1.

Referring to FIGS. 1 and 2, a motor 100 according to the present embodiment, which is a spindle motor 100 used in an optical disc drive rotating a disc D, is configured to include a bearing assembly 10, a base plate 50, a circuit board 60, a stator 30, and the rotor 40.

The bearing assembly 10 includes the shaft 11, a sleeve 13, a sleeve holder 14 supporting the shaft 11 and the sleeve 13.

The shaft 11 becomes a rotational axis of a rotor 40 to be described below. The shaft 11 according to the present embodiment may have a stopper ring coupling groove 12 formed at a lower end thereof in order to prevent the shaft 11 from being separated from the sleeve 13 due to the high speed rotation of a rotor case 44 to be described below, the stopper ring coupling groove 12 having a stopper ring 16 inserted thereinto.

The sleeve 13, having the shaft 11 inserted into a hole formed therein, is a rotation support member having an oil film formed between the sleeve 13 and the shaft 11 so that the shaft 11 may be easily rotated and supporting the shaft 11, and serves as a bearing. The sleeve 13 has an outer circumferential surface press-fitted into an inner portion of the sleeve holder 14 to be described below.

The sleeve holder 14, which is a fixed structure supporting the shaft 11 so as to allow it to be rotatable therein, supports the shaft 11 so as to be rotatable through the sleeve 13. The sleeve holder 14 includes a seating part 15 formed on an outer surface thereof, wherein the seating part 15 forms a step by partially protruding in the outer diameter direction so that the stator 30 to be described below is seated thereon.

In addition, the sleeve holder 14 includes a coupling rack 17 formed on the bottom thereof, wherein the coupling rack 17 protrudes downwardly in an axial direction to be coupled to the base plate 50 to be described below. The coupling rack 17 is bent to the base plate 50 through a caulking process, a spinning process, or the like, such that the base plate 50 is fixedly coupled to the sleeve holder 14.

The stator 30 is a fixed structure including a core 32 and a winding coil 34 wound around the core 32.

The core 32 is formed radially in the outer diameter direction of the shaft 11 based on the shaft 11, and is fixedly disposed on an upper portion of the sleeve holder 14.

The winding coil 34 is wound around the core 32 and generates electromagnetic force when power is applied thereto. The winding coil 34 according to the present embodiment is electrically connected to the circuit board 60 through a lead wire (not shown), and has external power supplied therethrough.

The rotor 40 includes a magnet 42 and the rotor case 44.

The magnet 42 is a ring shaped permanent magnet generating magnetic force having a predetermined strength by alternately magnetizing an N pole and an S pole thereof in a circumferential direction.

The rotor case 44 has a cup shape and includes a rotor hub 45 and a magnet coupling part 46.

The rotor hub 45 is press-fitted to and coupled with an upper end of the shaft 11, and is formed to be bent upwardly in an axial direction in order to maintain unmating force with the shaft 11. The rotor hub 45 has a chucking mechanism 48 formed on an outer circumferential surface thereof, wherein the chucking mechanism 48 may secure a disc loaded thereon.

The magnet coupling part 46, which has the magnet 42 coupled thereto, is formed along an inner circumferential surface of the rotor case 44. Here, the magnet 42 is disposed to face the core 32 having the winding coil 34 wound therearound. Therefore, when power is applied to the winding coil 34, the rotor 40 rotates due to electromagnetic interaction between the magnet 42 and the winding coil 34. The shaft 11 and the chucking mechanism 48 coupled to the rotor case 44 also rotate due to the rotation of the rotor 40.

The base plate 50, which is a support entirely supporting other components of the motor 100, is fixedly coupled to the above-mentioned sleeve holder 14, and has the circuit board 60 coupled to one surface thereof.

In the present invention, the circuit board 60 is fixed to the base plate 50 through a fixing member 90. To this end, the base plate 50 according to the exemplary embodiment of the present invention includes a support plate 51 and an insertion hole 52.

The support plate 51, which has a plate shape, has the circuit board 60 to be described below attached to one surface thereof.

The insertion hole 52 may vertically penetrate through the base plate 50, be formed in the inner portion of the base plate 50, and be formed in plural as needed. The insertion hole 52 has the fixing member 90 inserted thereinto, couples the circuit board 60 and the base plate 50 to each other and is formed in a position corresponding to a position in which an insertion hole 62 of the circuit board 60 to be described below is formed.

The fixing member 90 is inserted into the insertion hole 52 of the base plate 50 and the insertion hole 62 of the circuit board 60 to be described below, to thereby fixedly couple the base plate 50 and the circuit board 60 to each other. In addition, when the insertion hole 62 of the circuit board 60 is formed to have a conductive via hole connected to a ground pattern of the circuit board 60, the fixing member 90 may serve as a medium, electrically connecting the base plate 50 to the ground pattern of the circuit board 60.

The fixing member 90 may be a screw. However, the fixing member 90 is not limited thereto, but may also be a member inserted into and insertion-coupled or press-fitted with the insertion holes 52 and 62 and may also be formed to have a rivet shape to thereby couple the base plate 50 and the circuit board 60 to each other through press processing. When the fixing member 90 is formed to have the rivet shape, it may have flanges formed on both distal ends of an upper surface of the circuit board 60 and a lower surface of the base plate 50.

The circuit board 60 has circuit patterns (not shown) formed therein in order to apply power to the motor 100, and is electrically connected to the winding coil 34 to thereby apply power to the winding coil 34. In addition, the ground pattern of the circuit patterns of the circuit board 60 may be formed to be conducted to the base plate 50. To this end, as described above, the fixing member 90 may be used. As the circuit board 60, various boards such as a general printed circuit board (PCB), a flexible PCB, or the like, may selectively be used, as needed.

Meanwhile, in the present invention, double-sided adhesive tape is not included between the circuit board 60 and the base plate 50. In this case, a short-circuit may be generated between a terminal formed on the circuit board 60 and the base plate 50.

Therefore, the motor 100 according to the present embodiment includes an additional insulating layer 67 formed on a lower surface of the circuit board 60 contacting an upper surface of the base plate 50, such that insulating layers 67 formed on both surfaces of the circuit board 60 have different thicknesses. This will be described in detail with reference to FIG. 2.

The circuit board 60 according to the present embodiment includes a board body 64 including a core layer 65 and wiring layers 66 formed on both surfaces of the core layer 65, and the insulating layers 67 formed on outer surfaces of the wiring layers 66 so as to protect the board body 64.

The core layer 65 is formed in a surface direction and may be formed of an insulating plate made of a prepreg material and having a predetermined thickness.

The wiring layer 66 may be formed as at least one layer. In the present embodiment, the wiring layer 66 includes an upper wiring layer 66a formed on an upper layer of the core layer 65 and a lower wiring layer 66b formed on a lower surface of the board body 64.

The core layer 65 and the wiring layer 66 may be formed by thermally compressing copper foil layers on both surfaces of a prepreg sheet having a predetermined thickness and then patterning the copper foil.

In addition, the upper and lower wiring layers 66a and 66b of the circuit board 60 according to the present embodiment are electrically interconnected by at least one via hole 63 penetrating through the core layer 65. The via hole 63 is formed to penetrate through the circuit board 60 in a thickness direction thereof. In addition, the via hole 63 has a conductive member formed therein. The upper and lower wiring layers 66a and 66b are electrically interconnected through the conductive member.

The insulating layer 67 includes an upper insulating layer 68 formed on the upper wiring layer 66a and a lower insulating layer 69 formed on the lower wiring layer 66b, and protects the wiring layer 66 from an external environment.

In addition, in the lower insulating layer 69 according to the present embodiment, the circuit board 60 is electrically connected to the base plate 50 to thereby prevent a short circuit from occurring. To this end, the lower insulating layer 69 according to the present embodiment includes a first insulating layer 69a, a second insulating layer 69b, and a third insulating layer 69c.

The first and second insulating layers 69a and 69b may be formed across the lower surface of the circuit board 60, and be made of the same material. The present embodiment describes a case in which all of the first insulating layer 69a, the second insulating layer 69b, and the upper insulating layer 68 are made of a solder resist. However, the first insulating layer 69a, the second insulating layer 69b, and the upper insulating layer 68 are not limited thereto. Various materials such as an epoxy resin or the like may be used therefor.

The first and second insulating layers 69a and 69b may be formed by repetitively performing the same insulating layer forming process, and be formed to have a respective thickness of 15 to 25 μm, when the circuit board 60 has a thickness of 0.5 mm.

Meanwhile, when a single insulating layer is formed to have a thickness of 30 to 50 μm without separately forming the first and second insulating layers 69a and 69b as described in the present embodiment, a problem in which the insulating layer is separated from the circuit board after it is applied thereto, or a problem in which the insulating layer is not completely hardened during a process such as a thermosetting process, or the like, may occur. In order to prevent the occurrence of defects due to the above-mentioned problems, the first and second insulating layers 69a and 69b are formed as described above. However, in the case in which these problems are solved, the formation of the second insulating layer 69b according to the present embodiment may be omitted. That is, the first insulating layer 69a may be formed to have a thickness of 30 to 50 μm, and the third insulating layer 69c to be described below may be directly formed on the first insulating layer 69a.

The third insulating layer 69c is made of an insulating material, and is selectively formed in portions in which terminals are exposed to the outside on the lower surface of the circuit board 60. That is, the third insulating layer 69c is formed only in portions in which vias are formed or in portions in which element mounting terminals are formed on the lower surface of the circuit board 60.

When the circuit board 60 has a thickness of 5 mm, the third insulating layer 69c may be formed to have a thickness of 15 to 25 μm, and may be formed through a screen printing method (or a silk printing method), unlike the first insulating layer 69a, the second insulating layer 69b, and the upper insulating layer 68. Therefore, the third insulating layer 69c according to the present embodiment may be formed through a screen printing process according to the related art that has previously been performed in order to print various characters, symbols, or the like, onto a plate without performing a separate additional process.

Here, as an ink used for screen printing, an ultraviolet (UV) photopolymerizable resin ink and a solvent-based ink using a thermoplastic resin may be used. Since both the UV ink and the solvent-based ink are materials having insulating characteristics, they may be selectively used by a designer as needed.

Meanwhile, as needed, similar to those of the first and second insulating layers 69a and 69b, various materials such as a solder resist, an epoxy resin, or the like, may be used as a material of the third insulating layer 69c.

The circuit board 60 according to the present embodiment, having the above-mentioned configuration, includes the upper insulating layer 68 formed as a single layer on the upper surface thereof and the lower insulating layer 69 formed as three layers on the lower surface thereof, which is a bonded surface with the base plate 50, as described above. Therefore, the lower insulating layer 69 is thicker than the upper insulating layer 68 on the upper surface thereof, and the overall thickness of the insulating layer may be 45 to 75 μm.

Terminals exposed downwardly of the circuit board 60 are generally spaced apart from the lower surface of the circuit board 60 by the thickness of the lower insulating layer 69. In the motor 100 according to the present invention, the lower insulating layer 69 formed on the lower surface of the circuit board 60 is thicker than that of the related art, whereby the terminals of the circuit board 60 may be sufficiently spaced apart from the lower surface of the circuit board 60. Therefore, even though the lower surface of the circuit board 60 directly contacts the upper surface of the base plate 50, the generation of an electrical short circuit therebetween may be effectively prevented.

Next, a method of manufacturing a circuit board according to an exemplary embodiment of the invention will be described.

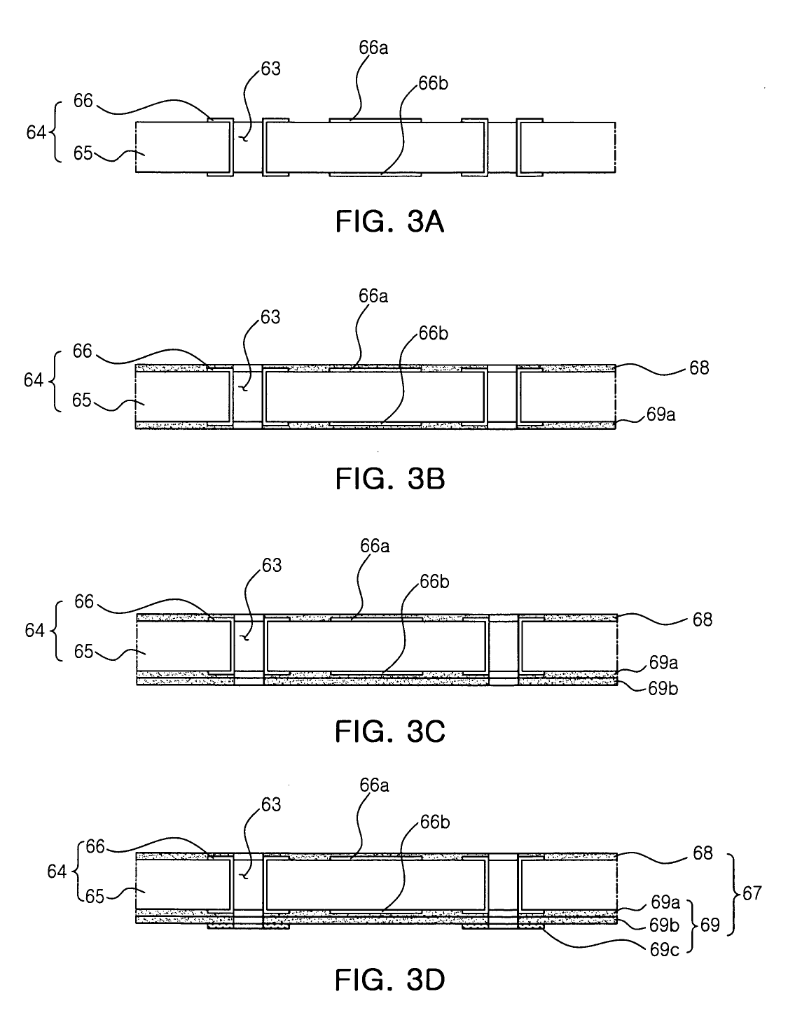

FIGS. 3A through 3D are views describing a method of manufacturing the circuit board of FIG. 1.

Referring to FIGS. 3A through 3D, in a method of manufacturing the circuit board according to the present embodiment, an operation of preparing the board body 64 having the wiring layers 66 formed on both surfaces of the core layer 65 is performed, as shown in FIG. 3A. The board body 64 may be formed by thermally compressing copper foil layers on both surfaces of a prepreg sheet forming the core layer 65 and then patterning the copper foil.

Then, an operation of forming the first insulating layer 69a on the lower surface of the board body 64 is performed, as shown in FIG. 3B. The first insulating layer 69a may be formed by applying a solder resist to the lower surface of the board body 64. The upper insulating layer 68 may be formed therewith by additionally applying the solder resist to the upper surface of the board body 64 in a process of forming the first insulating layer 69a. However, the present invention is not limited thereto.

Next, an operation of forming the second insulating layer 69b is performed, as shown in FIG. 3C. The second insulating layer 69b may be formed on the lower surface of the first insulating layer 69a through the same process as that of forming the first insulating layer 69a.

Meanwhile, if the upper insulating layer 68 is not formed in the above-mentioned operation of FIG. 3B, it may be formed together in the process of forming the second insulating layer 69b.

Thereafter, an operation of forming the third insulating layer 69c by performing a screen printing process is performed, as shown in FIG. 3D. The screen printing process is a process used for printing characters, symbols, or the like, on a board. In the method of manufacturing the circuit board 60 according to the present invention, the third insulating layer 69c is formed using the screen printing process according to the related art. Therefore, there is no need to perform a separate additional process for the formation of the third insulating layer 69c.

In the case of the circuit board 60 according to the present embodiment manufactured through the above-mentioned method, the first and second insulating layers 69a and 69b are made of the solder resist in order to secure a thickness of the thickness of the insulating layer 69 on the lower surface of the circuit board 60. However, the present invention is not limited thereto. Various methods may be employed so long as the thickness of the insulating layer 69 on the lower surface of the circuit board 60 may be secured.

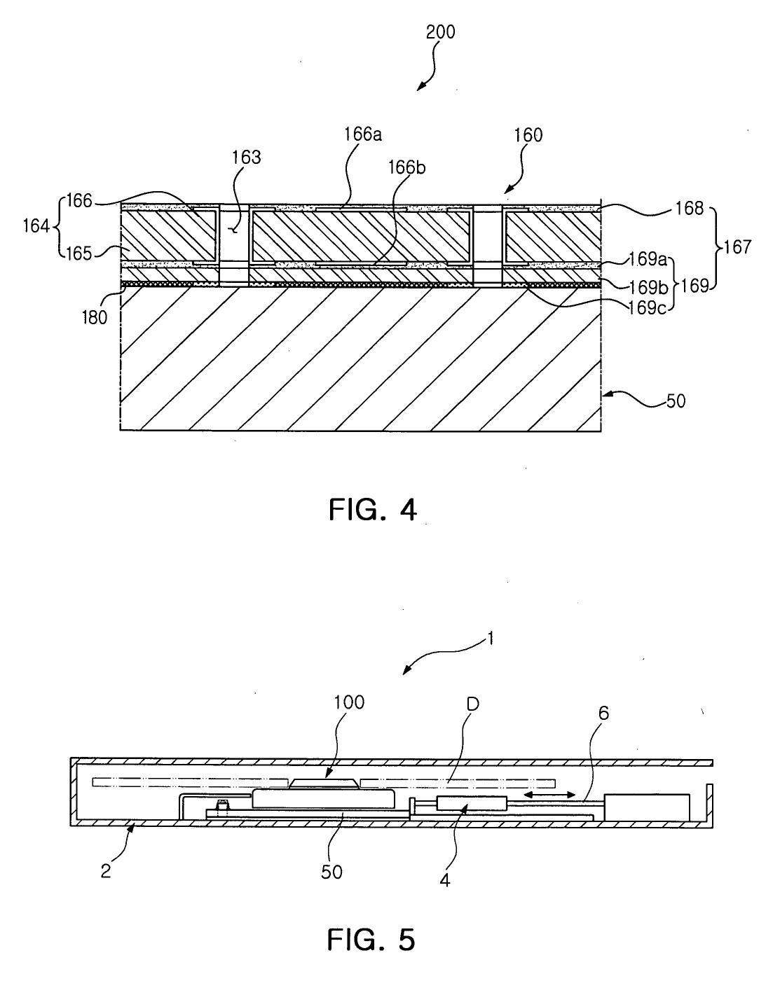

FIG. 4 is a cross-sectional view schematically showing a circuit board according to another exemplary embodiment of the present invention.

A motor 200 according to the present embodiment is configured to have a similar structure to that of the motor 100 (See FIG. 1) according to the above-mentioned embodiment, and is different therefrom only in the shape of an insulating layer 167 of a circuit board 160. Accordingly, a detailed description of the same components will be omitted, and the insulating layer 167 will be mainly described in detail.

Referring to FIG. 4, the circuit board 160 according to the present embodiment includes a board body 164 having a core layer 165 and a wiring layer 166 identical to those of the circuit board 60 of FIG. 2 described above.

In addition, the insulating layer 167 includes an upper insulating layer 168 formed on an upper wiring layer 166a and a lower insulating layer 169 formed on a lower wiring layer 166b, and the lower insulating layer 169 includes a first insulating layer 169a, a second insulating layer 169b, and a third insulating layer 169c.

Here, the upper insulating layer 168 and the first insulating layer 169a may be formed across an upper surface and a lower surface of the circuit board 160, respectively, and be made of the same material. In the present embodiment, both of the first insulating layer 169a and the upper insulating layer 168 are made of a solder resist.

In addition, the second insulating layer 169b is formed of a prepreg sheet. Here, the prepreg sheet forming the second insulating layer 169b is separately manufactured to have a shape corresponding to an external shape of the circuit board 160 and is then attached to a lower surface of the first insulating layer 169a. In this case, the prepreg sheet is provided in a B-stage state, is attached to the lower surface of the first insulating layer 169a, is completely hardened through a thermal compression process, and is adhered to the first insulating layer 169a.

Meanwhile, when the thermal compression process is performed on the prepreg sheet, the prepreg sheet in the B-stage state is changed to a liquid state through a phase change and is then hardened. Therefore, since the prepreg sheet may have a slightly reduced thickness, the thickness of the prepreg sheet may be slightly thicker than a desired thickness of the second insulating layer 169b.

Similar to the above-mentioned embodiment, the third insulating layer 169c may be selectively formed in portions in which terminals are exposed to the outside on the lower surface of the circuit board 160, and be formed through a screen printing method.

In the case of the circuit board 160 according to the present embodiment, the second insulating layer 169b is formed of the prepreg sheet, such that it may be formed to have a thickness desired by a designer.

Therefore, when the second insulating layer 169b is formed to have a sufficiently thick thickness, at least any one of the first insulating layer 169a and the third insulating layer 169c may be omitted and the lower insulating layer 169 may be formed as a single layer or two layers.

In addition, various configurations are possible as long as they are capable of increasing the thickness of the insulating layer 169 formed on the lower surface of the circuit board 160. For example, the first insulating layer 169a may be formed of a prepreg sheet and the second insulating layer 169b may be made of a solder resist.

In addition, the motor 200 according to the present embodiment includes an adhesive layer 80 interposed between the base plate 50 and the circuit board 160. The adhesive layer according to the present embodiment is formed only on an upper portion of the second insulating layer 169b, and is formed to have the same thickness as that of the third insulating layer 169c. Therefore, an increase in the overall thickness of the circuit board 160 and the base plate 50 due to the adhesive layer 80 may be prevented.

The adhesive layer 80 may be formed with an adhesive. Various materials capable of adhering the base plate 50 to the circuit board 160 may be used therefor.

When the fixing member 90 is used together with the adhesive layer 80 as in the motor 200 according to the present embodiment, the base plate 50 may be more firmly coupled to the circuit board 160, as compared to the above-mentioned embodiment in which only the fixing member 90 is used.

FIG. 5 is a cross-sectional view schematically showing an optical disc drive according to an exemplary embodiment of the present invention.

Referring to FIG. 5, an optical disc drive 1 according to the exemplary embodiment of the present embodiment includes the motor 100 according to the embodiment of FIG. 1 mounted therein. However, the present invention is not limited thereto. The optical disc drive 1 may include any one of the motors 100 and 200 according to the above-mentioned embodiments mounted therein.

The optical disc drive 1 according to the present embodiment may include a frame 2, an optical pickup mechanism 4 and a moving mechanism 6.

The frame 2 serves as a case of the optical disc drive 1, and has the base plate 50 of the motor 100 fixed to an inner portion thereof.

The optical pickup mechanism 4 is mounted so as to be movable in a space below a disc D loaded on the motor 100, and receives data from the disc D.

The moving mechanism 6 serves to transfer the optical pickup mechanism 4 in an outward diameter direction of the disc D to thereby receive data from the entire surface of the disc D.

As set forth above, with the motor and the optical disc drive using the same according to the exemplary embodiments of the invention, the insulating layer on the lower surface of the circuit board is enhanced to thereby be coupled to the base plate so as to be in direct contact therewith, without using the double-sided adhesive tape according to the related art. Therefore, the number of components in the motor is reduced, as compared to the related art, whereby a cost may be reduced and a process may be simplified.

In addition, the lower insulating layer on the lower surface of the circuit board is thicker than the upper insulating layer on the upper surface thereof, whereby the terminals of the circuit board may be sufficiently spaced apart from the lower surface of the circuit board. Therefore, even in the case that the lower surface of the circuit board directly contacts the upper surface of the base plate, the generation of an electrical short circuit therebetween may be effectively prevented.

Meanwhile, the motor and the optical disc drive using the same are not limited to the above-mentioned embodiments, but various modifications may be made by those skilled in the art without departing from the spirit and scope of the present invention.

In addition, although a case in which the motor is included in the optical disc drive has been described in the embodiment of the invention, the present invention is not limited thereto but may be variously applied to a motor having a structure in which a circuit board is attached to a base plate.

What is claimed is:

1. A motor comprising:
a base plate having a stator coupled thereto; and
a circuit board coupled to a surface of the base plate and having insulating layers formed on both surfaces thereof,
wherein the insulating layers formed on the both surfaces of the circuit board have different thicknesses.

2. The motor of claim 1, wherein an insulating layer formed on one surface of the circuit board attached to the base plate is thicker than an insulating layer formed on the other surface of the circuit board.

3. The motor of claim 2, wherein the insulating layer on one surface of the circuit board includes:
a first insulating layer formed on the circuit board;
a second insulating layer formed on the first insulating layer; and
a third insulating layer partially formed on the second insulating layer.

4. The motor of claim 3, wherein the first and second insulating layers are made of the same insulating material.

5. The motor of claim 4, wherein the insulating material is a solder resist.

6. The motor of claim 3, wherein the first and second insulating layers are made of different insulating materials.

7. The motor of claim 6, wherein the first insulating layer is made of a solder resist, and the second insulating layer is formed of a prepreg sheet.

8. The motor of claim 2, wherein the insulating layer on one surface of the circuit board is formed of a prepreg sheet.

9. The motor of claim 3, wherein the third insulating layer is formed through screen printing.

10. The motor of claim 3, wherein the third insulating layer is formed in portions of the circuit board in which terminals are exposed to the outside.

11. The motor of claim 3, wherein the third insulating layer is made of a resin material.

12. The motor of claim 3, further comprising an adhesive layer interposed between the base plate and the circuit board.

13. The motor of claim 12, wherein the adhesive layer is formed on an upper surface of the second insulating layer and has the same thickness as that of the third insulating layer.

14. The motor of claim 2, further comprising a fixing member fixedly coupling the circuit board and the base plate to each other.

15. The motor of claim 14, wherein the fixing member is any one of a screw or a rivet.

16. A motor comprising:
a base plate having a stator coupled thereto; and
a circuit board coupled to a surface of the base plate and having an insulating layer formed on a surface thereof contacting the surface of the base plate,
wherein the insulating layer has a thickness of 45 to 75 μm.

17. A motor comprising:
a base plate having a stator coupled thereto; and
a circuit board coupled to a surface of the base plate and having an insulating layer formed on a surface thereof (a contact surface) contacting the surface of the base plate,
wherein the insulating layer includes:
a first insulating layer formed across the contact surface of the circuit board; and
a third insulating layer formed on the first insulating layer and partially formed to correspond to portions of the circuit board in which terminals are exposed to the outside.

18. The motor of claim 17, wherein the insulating layer further includes a second insulating layer interposed between the first and third insulating layers.

19. The motor of claim 18, wherein the insulating layer has an overall thickness of 45 to 75 μm.

20. An optical disc drive comprising:
the motor of claim 1; and
an optical pickup mechanism mounted to be movable in a space below a disc loaded on the motor and receiving data from the disc.
